(19) United States
(12) Patent Application Publication
(10) Pub. No.: US 2003/0137196 A1
(43) Pub. Date: Jul. 24, 2003

(54) Power supply for providing continuous and regulated energy to the power user

(76) Inventor: Abraham Liran, Tarzana, CA (US)

Correspondence Address: ABRAHAM LIRAN, 4673 ELLENITA AVE, TARZANA, CA, 91356, US

(21) Appl. No.: 10/053,083

(22) Filed: Jan. 24, 2002

(51) Int. Cl. H02J 9/00

(52) U.S. Cl. 307/64

(57) ABSTRACT

A power supply system and a method to provide a smooth transition between utility power, transitory power and backup power in the event of a utility power failure to supply quality power to a load. As the utility power weakens due to a failure of the normal utility power supply, a synchronous machine becomes immediately a generator and supplies the required power to the load. In order to maintain the speed of the synchronous machine, kinetic energy needs to be transferred from a high speed flywheel using an “electrically controlled coupling” until the utility power recovers from its failure. Since the energy, which is stored in the flywheel, is limited, a standby engine will start and will continue to provide electrical power to the load either by turning a generator or by turning the flywheel.

### REFERENCE TO RELATED APPLICATION

The present application is related to two patents entitled “Power Supply for Providing Instantaneous Energy during Utility Outage” Dated: Feb. 1, 2000, U.S. Pat. No. 6,020,657 and Dated: Mar. 20, 2001, U.S. Pat. No. 6,204,572, by the same inventor but with no assignee.

### FIELD OF INVENTION

This invention relates to rotating electric machines for electric power generation. More specifically, the invention relates to generators and rotating flywheels as means to store energy for providing or furnishing regulated continuous power to sensitive loads.

### BACKGROUND OF THE INVENTION

Sensitive loads such as computers, data processing equipment, communication equipment and many others, need stable and uninterrupted electrical power. It is desirable to protect sensitive electrical instruments and machinery in cases that the energy source might fluctuate or cease. For such applications, it is necessary to use a power regulation system that is capable of correcting electrical power fluctuations and capable of transferring the load from one electrical source to another without affecting the quality of the electrical power to the load at any time. Another example, when using a gas or diesel engine to rotate a generator in order to produce and supply electricity to a load, the amount of gas or fuel usage is relative to the load. When the load is small, the needed amount of gas or fuel is small and the consumption of gas or fuel will increase if the load would be higher. There is a respond time delay, from the moment we have a change in the load to the time the system will adjust the required fuel amount to carry the new load. During this time respond, the power to the load will change and if frequency sensitive loads, such as computers, would be connected, the sensitive equipment will not function well. The power supply must be very accurate without any fluctuations. For such applications, it is necessary to use a power regulation system that is capable of correcting electrical power fluctuations. One of the existing methods to stabilize the power is to use rechargeable batteries. The problem with using batteries is that they have a limited lifetime, which depends on the number of times they have been charged and discharged. If batteries were used on spacecraft or space equipment, it would be difficult and some times impossible to replace them. Batteries are also heavy, occupy a lot of important space and are toxic. In addition, if the required power is AC, then it is necessary to convert the DC power coming from the battery to AC power. This conversion is not efficient and for high power, it is expensive.

British patent 1,309,858 discloses an uninterrupted power supply for ensuring that uninterrupted power is supplied to a load. This supply provides partial compensation to voltage drop by connecting an auxiliary power supply to the load via a secondary winding of a transformer, the primary winding of which is connected to a choke located between the main power supply and the supply. The use of a transformer disadvantageously makes the system expensive.

EP 69568 discloses an uninterrupted power supply using a high frequency method wherein a high frequency alternating current (AC) power generator drives a small, high-speed motor and flywheel that are both located in a sealed chamber. This approach is relatively expensive due to the use of an additional high frequency generator. Maintaining electric power frequency and phase within tolerances for sensitive or critical loads has also been a problem. Apparatus, which modifies frequency and other complex devices, have been used.

U.S. Pat. Nos. 4,827,152, 5,311,062 and 5,434,454 disclose uninterrupted power supplies having high-pressurized hydraulic system. These systems are unreliable since the high pressure piping included in these systems can burst. Furthermore, these systems do not provide the required frequency needed for such systems due to the need to accelerate the hydraulic motor at the outage instant.

U.S. Pat. No. 6,020,657 discloses uninterrupted power supplies using AC motors to turn the flywheel and at the instant of a power outage the AC motors becomes an Electromagnetic Clutch. This kind of clutch is not efficient and requires too much power to produce the required torque.

U.S. Pat. No. 6,204,572 is similar to the previous patent but instead of using the AC motor as a clutch between the flywheel and the synchronous machine, we are using a combination of induction coils and induction bars facing each other axially. This kind of clutch creates axial forces between the synchronous machine and the flywheel that requires big clearances between the two parts of the clutch, which means a less efficient clutch and requires special expensive bearings to carry the axial forces. In addition, the bearings between the common shaft and the flywheel are embedded inside the flywheel and it is difficult to replace and maintain.

There exist a need for a simpler and more effective power backup system which can substantially and instantaneously respond to utility failures of the line power without the disadvantages of heavy flywheels or high pressurized hydraulics or expensive electronics or inefficient clutches or difficult to maintain bearings. These and other disadvantages are solved or reduced using the present invention.

### SUMMARY OF THE INVENTION

The objective of this invention is to provide continuous stable power to sensitive or critical load when the energy source fluctuates or ceases.

This invention utilizes a rotating flywheel to store energy and thru an “electrically controlled coupling”, the kinetic energy that is stored in the flywheel can be transferred to a synchronous machine that will provide accurate power to the load. The kinetic energy stored in the flywheel can provide quality power to a load in two ways: 1. Using a synchronous machine that rotates as a motor when the utility power exists, and during utility loss, the synchronous machine becomes automatically a generator that provides electrical power to the load. The kinetic energy stored in the flywheel needs to be transferred thru the “electric controlled coupling” to the synchronous machine in order to maintain constant speed at the rotor of the synchronous machine. In parallel, a stand by “engine+generator” starts and the power to the load will be transferred without any significant interruption from the synchronous machine to the “engine+generator”.

2. If the utility source is an “engine+generator” and during normal operation its power might fluctuate, the system can regulate those fluctuations and provide stable power by connecting electrically the synchronous machine to the “engine+generator”, and in case that the power from the “engine+generator” will fluctuate, the “control unif” will sense the fluctuations and will transfer power to the “electric controlled coupling” which will create an electromagnetic torque between the flywheel and the synchronous machine. This electromagnetic torque will transfer kinetic energy from the flywheel to the synchronous machine. The electrical power output from the synchronous machine will add to the power from the “engine+generator” going to the load and the total power will provide quality power to the load.

The rotary power supply system comprises a motor that turns the flywheel at a high speed. Next to the flywheel, on the same axis but separated from the flywheel, thru a small radial air gap, there is an “electrically controlled coupling”. This patent shows two kinds of “electrically controlled coupling”. The first kind is based on electromagnetic coils that when energized they create an electromagnetic field and creates a torque between the two rotating parts. The strength of the torque depends on the strength of the electromagnetic field between the two rotating parts. The second option to have an “electrically controlled coupling” is using a combination of a hydraulic pump and an electromagnetic plunger that can control the amount of oil that leaves the pump (see FIG. 4). When the outlet of oil from the pump is not restricted, there is no coupling between the two rotating parts. However, when the outlet oil path is restricted thru the electromagnetic plunger, the two rotating parts will be coupled and torque can be transferred between the two rotating parts. The following describes the first kind of coupling: The “induction transformer” is a method to transfer electricity from a stationary coil to a rotating coil thru induction between the two coils. The “induction transformer” has its core separated into two parts: one for the primary stationary windings and the other for the secondary rotating winding. The primary winding is electrically connected to the “electronic control unit”. The “electronic control unit” will transmit AC voltage power to the primary coil of the “induction transformer”, and thru induction, the secondary coil will be energized. The AC voltage will be rectified to DC thru diodes and it will transfer the DC power to the electromagnetic coils in the coupling. The “electronic controller” will monitor the voltage or frequency coming out of the synchronous machine, and thru the “induction transformer”, it will supply electrical power to the “electrically controlled coupling”. By regulating the voltage to the “electrically controlled coupling”, it is possible to control the exact amount of energy we need to transfer from the flywheel to the generator in order to maintain accurate power to the load. The “electrically controlled coupling” comprises of circular electromagnetic coils attached to the shaft that is coupled to and rotates with the synchronous machine. When the coils are energized, a magnetic field creates a torque between the flywheel and the shaft of the synchronous machine. The “electronic controller” monitors the voltage and frequency going to the load and controls the amount of kinetic energy transferred from the flywheel to the generator by changing the electrical voltage going into the primary coil in the “induction transformer”. The following describes the second method of transferring kinetic energy from the flywheel to the synchronous machine, using a combination of a hydraulic pump with electro magnetically controlled plunger. Thru the center of the flywheel's shaft, exist an axial opening and this opening continuous radially to the shaft. When the flywheel turns and oil is introduced to the axial opening of the shaft, the oil will be sucked into the shaft because the radial opening in the shaft acts as a centrifugal pump. The oil is than pushed and circulating by wipers to an outlet exists in the common shaft. The plunger can slide axially around the common shaft and together with the electromagnetic coil that is attached to the support, can block the oil totally or partially from leaving the common shaft. This creates a hydraulic coupling between the flywheel and the synchronous machine and controls the amount of kinetic energy that can be transferred between the two.

During normal operation, the flywheel is rotating at a higher speed than the synchronous machine, but its speed may vary. The “electronic control” unit senses the voltage or frequency on the load and regulates the electromagnetic friction between the flywheel and the generator thru the “electrically controlled coupling” in order to transfer the exact amount of kinetic energy to the load.

In the preferred form, the power supply system comprises a power supply assembly having a compact design. The assembly comprises a “common shaft” that is coupled to a synchronous machine. The “common shaft” rotates at the speed of the synchronous machine in the same direction as the flywheel at about half of the speed of the flywheel. This method enables to minimize the bearing speed and to increase the bearing life because the bearings of the flywheel are rotating at only the relative speed between the “common shaft” and the flywheel. Both sides of the “common shaft” are supported thru bearings to the machine support. The flywheel rotates by the “flywheel motor”. The “flywheel motor” can be a regular electrical motor or a gas or diesel engine or made of blades that are turned by the wind power or geothermal engine or hydraulic motor or other devices that can provide rotational power to the flywheel.

The method comprises the steps of rotating a flywheel at a much higher speed than the speed of the synchronous machine. The “electronic control unit” constantly monitors the power quality to the load and if it senses degradation in the power quality, then it will energize the “electrically controlled coupling” that will transfer thru magnetic field the required kinetic energy from the flywheel to the synchronous machine in order to achieve the desired power to the load. Using this method, the load is totally isolated from any energy fluctuations coming from the energy source.

### BRIEF DESCRIPTION OF THE DRAWINGS

FIG. 1 is a block diagram of the power supply system for delivering continuous, smooth, quality power to a load by using flywheel kinetic energy and “electrically controlled coupling”. In case of sensing a utility loss, the system will disconnect the load from the utility power, will start the emergency diesel or gas engine and when the engine will reach its operational speed, the system will transfer the power supply to the standby “engine+generator” without any power interruption. In case that the “engine+generator” supplies power to the load and the electrical power fluctuates, the system will regulate the power to the load by supplying additional power from the kinetic energy stored in the flywheel to the synchronous machine, thru the “electrically controlled coupling”.

FIG. 2 is a mechanical drawing of the power supply assembly using electromagnetic coils to create the required coupling between the flywheel and the synchronous machine.

FIG. 3 is another option to provide continuous quality power to a load using electromagnetic coils to create the required coupling between the flywheel and the synchronous machine. In this option, we have “electrically controlled couplings from both sides of the flywheel. The first “electrically controlled coupling” is connected to the synchronous machine and the second “electrically controlled coupling” is connected to both—an electrical motor and an engine thru an “over running clutch”. The over running clutch will engage only when the speed of the engine will be more than the speed of the shaft of the second “electrically controlled coupling”. During normal conditions, the electrical motor turns the flywheel at high speed thru the second “electrically controlled coupling”, the synchronous machine turns as a motor while the engine is resting. During power emergency, the synchronous machine becomes a generator. Kinetic power will be transferred from the flywheel to the generator thru the first “electrically controlled coupling” between them. In parallel, the engine will start, and when its rotational speed will be above the flywheel speed, kinetic energy will transfer from the engine to the flywheel thru the second “electrically controlled coupling”. As long the speed of the flywheel is above the required speed for the synchronous machine, the system will provide quality power to the load because the “electrically controlled coupling” will be able to maintain accurate speed to the synchronous machine.

FIG. 4 shows a different method to transfer kinetic energy from a flywheel to the synchronous machine, using a combination of hydraulic pump and an electro magnetically controlled plunger.

### DETAILED DESCRIPTION OF THE PREFERRED EMBODIMENT

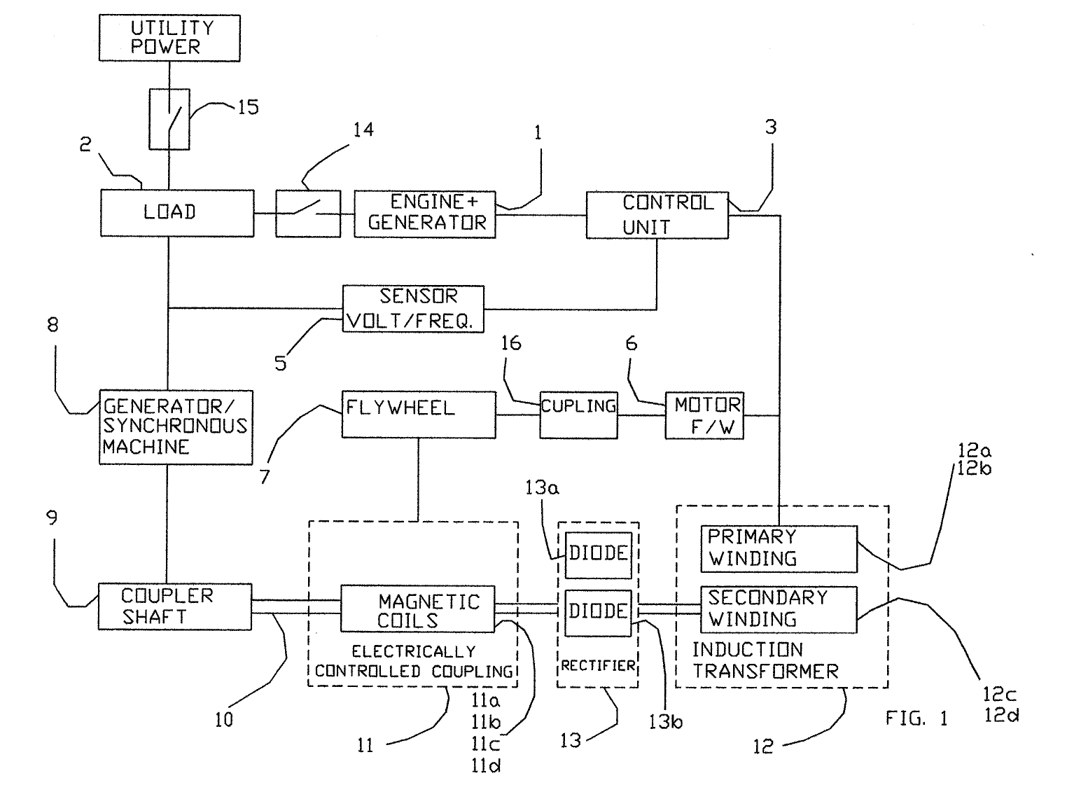

A description of the invention is provided with figures using reference designations. Referring to FIG. 1, the “control unit” 3, senses the voltage and or frequency from the generator 8. The motor flywheel 6 drives a flywheel 7 thru coupling 16. The “control unit” 3, sends electrical signals to the primary windings 12a and 12b, which are an integral part of the “induction transformer” 12. The secondary windings 12c and 12d are transferring the electrical signals thru diodes 13a and 13b to the electromagnetic coils 11a, 11b, 11c and 11d that are part of the “electrically controlled coupling” 11. If the electric power to the electromagnetic coils increases or decreases, the amount of magnetic friction between the flywheel 7 and the generator 8 would change. The kinetic energy would be transferred thru a “coupler shaft” 9 to the generator 8. The power from the generator 8 would be transferred to load 2.

The utility power 1 could be for example: main power utility, local diesel or gas engine, solar array, wind fans, geothermal or any other energy source which could fluctuate and we need to transform the energy power to a stable electrical power. During normal operation, the utility power 1 turns the synchronous machine as a motor at a low speed and also turns the flywheel 7 at a higher speed using “motor f/w” 6.

The “control unit” 3 senses the frequency going to the load through sensor 5. If the “control unif” detects a change in frequency, it would command to transfer electrical power to the “electrically controlled coupling” 11 in order to create the right amount of torque strength that is required between the flywheel and the generator to maintain the adequate frequency and voltage to load 2.

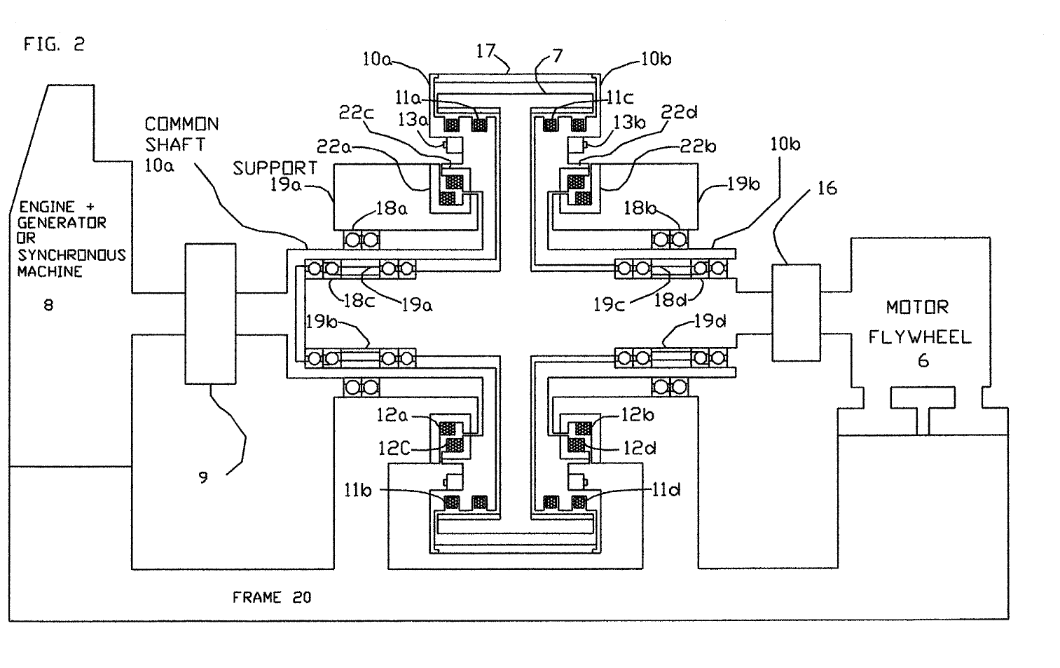

Referring to FIG. 1 and more particularly to FIG. 2, a preferred power supply assembly is shown comprising the generator 8, “coupler shaft” 9, and “electrically controlled coupling” 11 which includes the “common shaft” 10a and 10b, primary transformer coils 12a and 12b, secondary transformer coil 12c and 12d, diode 13a and 13b and magnetic coils 11a, 11b, 11c and 1d. The “common shaft” 10a is supported by a set of bearing 18a to the support 19a and “common shaft” 10b is supported by a set of bearing 18b to the support 19b. The “common shaft” 10a and 10b supports the flywheel 7 thru two sets of bearing 18c and 18d. Between the electromagnetic coils 11a, 11b, 11c, 11d and the flywheel 7 there exists a radial air gap.

The “induction transformer” 12, has a set of primary winding 12a attached to support 19a and 12b attached to support 19b, and respectively, a set of secondary winding 12c attached to “common shaft” 10a and another secondary winding 12d, attached to “common shaft” 10b. The windings 12a, 12b, 12c and 12d are circular coils, facing each other radially or axially. The coils are encapsulated within laminated sheets of magnetic conductive material 22a, 22b, 22c and 22d.

The magnetic coils 11a, 11b and 11c, 11d are on the “common shaft” 10a and 10b, facing radially toward the flywheel and are electrically connected to the secondary windings 12c and 12d of the “induction transformer” 12 thru the diodes 13a and 13b. The magnetic coils 11a, 11b, 11c and 11d are wound copper wire coils of preferable 500 turns conducting 100 amps, inserted in circular radial grooves slotted in the common shaft 10a and 10b.

Bearing 18a, 18b, 18c and 18d are preferably ball bearings such as SKF bearing 6036 to take radial loads as well as axial loads. Other kinds of bearings are possible as well, including magnetic and electromagnetic bearings, oil or air bearings.

The flywheel 7 has a cylindrical shape. It has a shaft through the center where bearings 18c and 18d enable it to rotate inside the common shaft 10a and 10b. The flywheel material is preferably made out of steel or alloy steel. The radial surfaces of the flywheel facing the magnetic coils need to be slotted axially to increase the efficiency of the coupling effect. The axial slots can be about 36 grooves equally spaced around the flywheel surface facing the electromagnetic coils, 1 inch wide and 1 inch deep.

The sensor 5 could be a magnetic, optical or electrical sensing devise for measuring the rotational speed or electrical output frequency of the generator 8. The sensor 5 can be an optical sensor sensing printed marking, for example, white paint marking on coupler 9. The sensor 5 would have a LED (not shown) illuminating the white marking and reflecting the light back to a photo-detector (not shown) of the sensor 5. When the white marking on coupler 9 is rotated into position that can be detected by the photo-detector, the sensor 5 generates a pulse. The time between pulses can determine the rotational speed of the generator's shaft 8. An exemplar photo-detector sensor 5 is a Macmaster part number 7011K32. Alternative sensor 5 could include a magnetic sensor having a magnet attached to the outer core of one of the parts that rotates with the shaft of the generator (not shown) and a sensing device that detects the magnetic flux. Exemplary induction sensor is the Mac master part number 18705T51. Approximate sensor could be used to sense the rotational speed of the shaft of generator 8. An exemplar proximity sensor is the Macmaster part number 7674K68 sensor. Another way to measure the rotational speed of the generator is using a frequency detector, for example a M100-F1 frequency detector made by MultiTech.

The present invention as shown thru the drawing in FIG. 1 has, from both sides of the flywheel: two “common shafts” 10a and lob, two “inductive transformer” 12a and 12b and two magnetic coils 11a and 11b. However, the present invention can also have only one “common shaft” 11a, one “induction transformer” 12a and one set of magnetic coil 11a. On the drawing shown in FIG. 2 is shown that there are two magnetic coils 11a and 11b on one side of the flywheel, and 11c and 11d on the other side of the flywheel. However, the number of magnetic coils between the “common shaft” and the flywheel can be any number.

The reason for using a “common shaft” 10 is to reduce the speed of the bearings thereby providing a longer life, however, it is not a necessity for the present invention. It is possible to use only one set of bearing to support the flywheel from each side. This kind of design requires to select bearings that can survive twice the speed than if using the method shown in FIG. 2. This can be done by using magnetic bearings, hydraulic journal bearings or other kind of bearing.

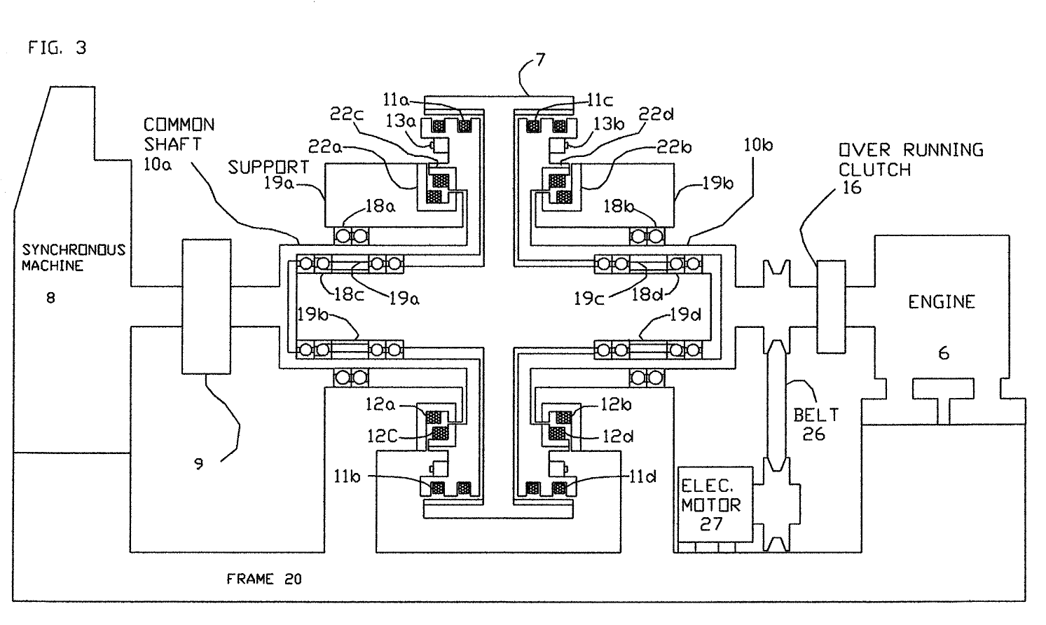

Referring to FIG. 3. On one side of the flywheel 7, the first “electrically controlled coupling” which is comprised of the magnetic coils 11a and 11b, diodes 13a and induction coils 12a and 12c, is connected thru the common shaft 10a and thru the coupling 9 to the synchronous machine. On the other side of the flywheel 7, the second “electrically controlled coupling” is connected thru the common shaft 10b to the “over running clutch” 16 and to an electric motor 27 by preferably belt 26. The electric motor 27 could also drive the common shaft 10b thru a gear or a direct drive—not shown on this drawing. On the other side of the “over running clutch” 16 attached is the shaft of an engine 6. The engine 6 can be using: gas, diesel, geothermal, solar, wind, water turbines, solar, atc.

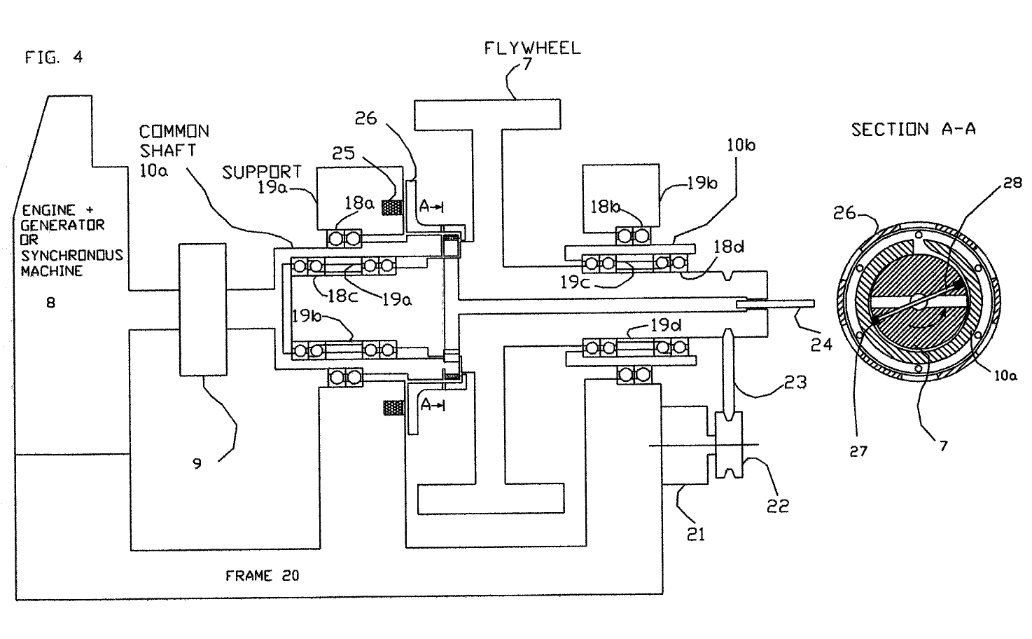

Referring to FIG. 4. On one side of the flywheel 7, the “electrically controlled coupling” is comprised of a hydraulic pump and electromagnetic plunger contain the following parts: wipers 27—preferably two blades rotating with the flywheel shaft 7 and can slide radially between the flywheel shaft 7 and inside an eccentric groove on the common shaft 10a facing the flywheel shaft. The two wipers 27 are separated by a separating rod 28 that can slide inside a radial hole drilled in the flywheel shaft 10. The common shaft 10a has radial openings, to allow the oil that comes out of the flywheel shaft 7 to leave. In addition, it has axial holes (preferably as shown—6 holes) to push the plunger 26 axially, in order to clear the oil outlet when the electromagnetic coil 25 is not energized. The electromagnetic coil 25 has about 200 turns and has a ring shape. The plunger 26 is made out of ferromagnetic material. It is a circular sleeve and slide around the common shaft 10a with a small clearance between them, and has a vertical lip facing the electromagnetic coil 25. The other side of the flywheel shaft 7 is connected preferably thru a belt drive 23 to an electrical motor 21. Another method to turn the flywheel could be by using a direct electric motor drive—not shown in this drawing.

What is claimed is:

1. A method for providing continuous stable power to a load even if the power from the power source fluctuates or ceases. The method comprises the steps of rotating a flywheel at high speed to store kinetic energy and rotating a synchronous machine at a lower speed.
Magnetically or hydraulically, couple the flywheel to a generator through an “electrically controlled coupling” that is controlled by a computer.
Monitoring the power to the load and correcting any power fluctuations to the load continuously by supplying controlled power to the “electrically controlled coupling” that can transfer the right amount of the kinetic energy from the flywheel to the synchronous machine in order to provide accurate and stable power to the load.

2. The method of claim 1 further comprises the step of using the “flywheel motor” to rotate the flywheel at high speed and to rotate the common shaft by the synchronous machine at about half the speed of the flywheel in order to minimize the rotating speed of the bearings.

3. The method of claim 1 further comprises the steps of:
Sensing electrical utility failure or electrical power fluctuations.
In case of utility fail, disconnecting the load from utility and supplying the load with electrical power from the synchronous machine that gets its power from the flywheel thru the “electrically controlled coupling”, starting an “engine+generator”, checking the phases and when the phases coincide and transferring the load to the “engine+generator”. When utility power restores, checking the phases and when the phases coincide, transferring the load back to utility and stopping the engine.
In case that the utility comprises of a local “engine+generator” and the power to the load fluctuates, the “control unit” will sense the fluctuations and will continuously control the “electrically controlled coupling” to transfer kinetic energy from the flywheel to the synchronous machine, thereby providing quality electrical power to the load.

4. The method of claim 1 further comprises the use of an “electrically controlled coupling” that has magnetic coils attached to the shaft that is connected to the synchronous machine and faces radially to the flywheel thru a small air gap. Alternatively, using a hydraulic pump combined with an electro magnetically controlled plunger, between the flywheel shaft and the synchronous machine shaft, to create a controlled coupling for transferring kinetic energy from the flywheel to the synchronous machine.

5. A method of claim 1 further comprises a way to transfer AC power from a stationary coil to a rotating coil, using laminated ferromagnetic sheets inserted radially or axially as two rings, into two opposite housings—the stationary housing and the rotary housing and having a small air gap between the laminations with the stationary coil and the laminations with the rotating coil.

6. A method of claim 1 further comprises the possibility to turn a flywheel at high speed using an electrical motor for normal operation and an engine during utility power failure. The “synchronous machine” rotates as a motor during normal operation, but at a lower speed than the flywheel. An “electrically controlled coupling” exists between the flywheel and the synchronous machine and another “electrically controlled coupling” exists between the flywheel and an engine. In case that the utility power to the load fluctuates or ceases, the “electrically controlled coupling” between the flywheel and the synchronous machine will transfer kinetic energy from the flywheel to the “synchronous machine”, to maintain quality power to the load. Thru the “electrically controlled coupling” between the flywheel and the engine, the engine will transfer continuous power to the flywheel. The engine can use energy from a variety of energy sources such as wind, water, geothermal, gas and diesel.
